(19) United States
(12) Patent Application Publication
(10) Pub. No.: US 2007/0187327 A1
(43) Pub. Date: Aug. 16, 2007

(54) MINERAL IONS IN STRUCTURED WATER

(76) Inventors: Liliana Sophie George, Centerport, NY (US); George Cioca, Lake Grove, NY (US); Ionita-Manzatu Vasile, Old Bethpage, NY (US); Kretzschmar-Dovi Kathleen Mary, Smithtown, NY (US); Mirela Cristina Ionita-Manzatu, Old Bethpage, NY (US)

Correspondence Address: THE ESTEE LAUDER COS, INC, 155 PINELAWN ROAD, STE 345 S, MELVILLE, NY, 11747, US

(21) Appl. No.: 11/673,119

(22) Filed: Feb. 9, 2007

Related U.S. Application Data
(60) Provisional application No. 60/772,274, filed on Feb. 10, 2006.

(51) Int. Cl. B01D 61/00

(52) U.S. Cl. 210/639; 426/66; 426/74; 210/650; 424/600; 423/580.1

(57) ABSTRACT

The present invention relates to enhanced structured water containing mineral ions that are released by water-insoluble minerals and integrated into water clusters in the structured water. Specifically, the present invention provides compositions containing structured water selected from the group consisting of I water, S water, and a combination thereof. The structured water includes at least one charged cluster of water molecules having at least one mineral ion bound therewith to form a cluster complex. The mineral ions in the cluster complex exhibit enhanced biological activities, in comparison with mineral ions in un-structured waters. Further, by incorporating at least one bridging agent, and at least one capping agent into the cluster complex, the compositions of the present invention exhibit bright and intense colors with surprising and unexpected color stability.

This application claims priority under 35 U.S.C. 119 of provisional application 60/772,274, filed 10 Feb. 2006.

### FIELD OF THE INVENTION

The present invention relates to structured water and compositions containing structured water. In particular, the invention relates to enhanced structured water containing mineral ions released by water-insoluble minerals, which are integrated into water clusters of the enhanced structured water to form cluster complexes. The mineral ions in such cluster complexes exhibit significantly improved biological activities (such as collagenase-inhibiting activity, collagen-synthesis-enhancing activity, free-oxygen-radical-inhibiting activity, etc.), in comparison with mineral ions in un-structured waters. Further, upon incorporation of at least one bridging agent and at least one capping agent into the cluster complexes, the compositions of the present invention exhibit bright and intense colors with surprising and unexpected color stability.

### BACKGROUND OF THE INVENTION

The biological roles of essential ions extracted from minerals have been documented in the art. See Inflammation Research Vol. 2, pp 281-291, Ed. G. Weissman, B. Samuelson and R. Paoletti Raven Press, New York 1979, which discusses the various biological activities of essential mineral ions (e.g., copper, manganese, silicon and selenium ions), such as, for example, anti-inflammatory activity, anti-oxidant activity, and collagen-synthesis-enhancing activity.

However, the minerals containing such essential ions are mostly water-insoluble. In order to disperse such water-insoluble minerals in water to form a stable dispersion, it is necessary to grind the water-insoluble minerals into fine particles. Further, such water-insoluble minerals typically have a specific gravity of about 1.5 or more, which causes the mineral particles to easily precipitate out of water. Various studies have been performed to obtain relatively stable dispersions of water-insoluble minerals in water by adsorbing and retaining primary fine particles in three-dimensional network structure of crystalline cellulose or mucopolysaccharides by adding the crystalline cellulose and the mucopolysaccharides to water (Japanese Patent Laid-Open No. Sho. 56-117758 and Japanese Examined Patent Publication No. Sho. 57-35945). There are also known methods of alleviating specific gravity by adding water-insoluble mineral particles to fats and oils, dispersing the particles therein, and adjusting the content of fats and oils in the resulting mixture to about 30% by weight or more (Japanese Patent Laid-Open No. Sho. 57-110167).

However, the minerals in the above-described compositions remain as water-insoluble particles, and the essential ions in such minerals are neither solubilized nor integrated into the water structure.

There is therefore a need for forming stable compositions containing essential ions that are released by water-insoluble minerals and are solubilized and integrated into the water structure.

### SUMMARY OF THE INVENTION

It has been discovered by the inventors that structured water is particularly effective for forming stable solutions containing mineral ions from water-insoluble minerals. Structured waters, such as I water and S water, as well as the methods of forming same, have been described in detail by Romanian Patents No. RO 88053, RO 88054, RO 107544, RO 107545, and RO 107546; UK Patent Application Publication No. GB 2335142; and U.S. Pat. Nos. 5,846,397, 6,139,855, 6,231,874, 6,451,328, and 6,958,163, the contents of which are incorporated herein by reference in their entireties for all purposes.

In one aspect, the present invention relates to a composition comprising structured water selected from the group consisting of I water, S water, and a combination thereof, wherein said structured water comprises at least one charged cluster of water molecules having at least one mineral ion bound therewith to form a cluster complex.

Suitable mineral ions that can be incorporated into the composition of the present invention include, but are not limited to: copper, manganese, selenium, silicon, zinc, iron, aluminum, calcium, potassium, sodium, lithium, magnesium, silver, etc. Preferably, but not necessarily, the mineral ions are positively charged ions selected from the group consisting of copper, manganese, selenium, silicon, zinc, and iron. More preferably, the mineral ions comprise copper or manganese ions.

Exemplary water-insoluble minerals useful for practicing the present invention include, but are not limited to: malachite (containing copper ions and having the formula of CuCO₃.Cu(OH)₂), azurite (containing copper ions and having the formula of 2CuCO₃.Cu(OH)₂), chrysocolla (containing copper ions and having the formula of CuSiO₃.nH₂O), rhodochrosite (containing manganese ions and having the formula of MnCO₃), rhodonite (containing, inter alia, manganese ions and having the formula of (Mn,Fe,Mg,Ca)SiO₃), tourmaline (containing silicon ions in form of a complex silicate of aluminum, boron, and other elements), ruby (containing aluminum ions and having a formula of Al₂O₃::Cr), calcite (containing calcium ions and having a formula of CaCO₃), hematite (containing iron ions and having a formula of Fe₂O₃), and combinations thereof. Preferably, the water-insoluble mineral used in the present invention is a Cu— or Mn-containing mineral, such as malachite, azurite, chrysocolla, rhodochrosite, or rhodonite.

When the cluster complex contains only the charged cluster of water molecules and the mineral ion, the composition of the present invention is a colorless solution. However, when at least one bridging agent and at least one capping agent are incorporated into the cluster complex in addition to the mineral ion, the composition of the present invention exhibits a bright and intense color with unexpected and surprising color stability.

The term “bridging agent” as used herein refers to an agent that is capable of bonding to the charged cluster of water molecules to facilitate electron movements within the cluster complex and to impart colors to the overall composition. Examples of suitable bridging agents for practice of the present invention include organic acids, such as, for example, citric acid, salicylic acid, glutamic acid, and aspartic acid.

The term “capping agent” as used herein refers to an agent that is capable of bonding to the charged clusters of water molecules to balance electric charges within the cluster complex and to fix/stabilize the colors of the overall composition. Selection of capping agents depends on the specific types of structure water used in the composition. For example, capping agents suitable for use in compositions containing I water include positively charged amino acids, such as arginine, lysine, and histidine, or additional I water. For another example, capping agents suitable for use in compositions containing S water include additional S water.

Compositions of the present invention containing the mineral ion, the bridging agent, and the capping agent may exhibit various bright intense colors, such as violet, blue, green, yellow, and red. More importantly, such colors are surprisingly and unexpectedly stable, as indicated by color stability tests conducted at an elevated temperature of about 50° C. with no observed color fading or color precipitation for at least four (4) weeks.

In one specific embodiment of the present invention, the composition comprises I water with negatively charged clusters of water molecules therein. At least one of such negatively charged clusters of water molecules is bound with copper ions, citric acid, and L-arginine to form the cluster complex. Such a composition exhibits a stable blue color.

In an alternative embodiment of the present invention, the composition comprises I water with negatively charged clusters of water molecules therein. At least one of such negatively charged clusters of water molecules is bound with copper ions, glutamic acid, and L-arginine to form the cluster complex. Such a composition exhibits a stable violet color.

In another alternative embodiment of the present invention, the composition comprises S water with positively charged clusters of water molecules therein. At least one of such positively charged clusters of water molecules is bound with salicylic acid, copper ions, and additional S water to form the cluster complex. Such a composition exhibits a stable green color.

In yet another alternative embodiment of the present invention, the composition comprises I water with negatively charged clusters of water molecules therein. At least one of such negatively charged clusters of water molecules is bound with manganese ions, citric acid, and L-arginine to form the cluster complex. Such a composition exhibits a stable yellow color.

In a further alternative embodiment of the present invention, the composition comprises S water with positively charged clusters of water molecules therein. At least one of such positively charged clusters of water molecules is bound with salicylic acid, manganese ions, and additional S water to form the cluster complex. Such a composition exhibits a stable red color.

The compositions of the present invention may further comprise one or more fragrances, which are solubilized and incorporated into the cluster complex without use of any solubilizer. In other words, the compositions of the present invention are essentially free of solubilizer.

The present invention in another aspect relates to a method of forming a composition, comprising mixing particles of a water-insoluble mineral with I water, wherein at least a portion of the water-insoluble mineral is solubilized and releases at least one positively charged mineral ion to bond with at least one negatively charged cluster of water molecules in the I water and form a cluster complex. Preferably, but not necessarily, the water-insoluble mineral particles as described hereinabove have an average particle size ranging from about 1 micron to about 1 mm, and more preferably from about 10 microns to about 0.1 mm.

In order to impart colors to the resulting composition, it is preferred to further add at least one bridging agent as described hereinabove into the mixture to bond with the at least one positively charged mineral ion and form a part of the cluster complex. It is more preferred that at least one capping agent as described hereinabove is added into the mixture to bond with the at least one bridging agent and enhance color stability of the resulting composition. Further, un-dissolved particles of the water-insoluble mineral is removed from the mixture by filtration, e.g., using a filter having a retention threshold ranging from about 0.01 micron to about 1 micron. Such filtration is preferably carried out after addition of the at least one bridging agent, but before addition of the at least one capping agent.

In a further aspect, the present invention relates to a method for forming a composition, comprising:
adding at least one bridging agent into S water, wherein the at least one bridging agent comprises an organic acid selected from the group consisting of citric acid, salicylic acid, glutamic acid, and aspartic acid for bonding with at least one positively charged cluster of water molecules in the S water; and
mixing particles of a water-insoluble mineral with the S water and bridging agent mixture, wherein at least a portion of the water-insoluble mineral is solubilized and releases at least one positively charged mineral ion for bonding with the at least one bridging agent to form a cluster complex.

Preferably, but not necessarily, the water-insoluble mineral particles as described hereinabove have an average particle size ranging from about 1 micron to about 1 mm, and more preferably from about 10 microns to about 0.1 mm. It is also preferred to add additional S water as a capping agent into the mixture for bonding with the positively charged mineral ion and forming a part of the cluster complex. Further, un-dissolved particles of the water-insoluble mineral can be removed from the mixture by filtration after mixing particles of the water-insoluble mineral with the S water and bridging agent mixture, but before addition of the additional S water.

Other aspects and objectives of the present invention will become more apparent from the ensuring description, examples, and claims.

### DESCRIPTION OF THE DRAWINGS

FIG. 1 is a bar chart illustrating the free oxygen radical inhibition activities exhibited by samples formed by mixing malachite powder with I water, in comparison with samples formed by mixing malachite powder with de-ionized water.

FIG. 2 is a bar chart illustrating the anti-collagenase (or collagenase inhibition) activities exhibited by samples formed by mixing malachite powder with I water, in comparison with samples formed by mixing malachite powder with de-ionized water.

FIG. 3 is a bar chart illustrating the collagenase inhibition activities exhibited by samples containing malachite powder, L-glutamic acid, and L-arginine in I water, in comparison with samples containing the same components in de-ionized water.

FIG. 4 is a bar chart illustrating the collagen synthesis activities exhibited by samples containing rhodochrosite powder and citric acid in I water, in comparison with a positive control sample containing 18 μg/ml of MAP (Magnesium-Ascorbil-Phosphate).

FIG. 5 is a bar chart illustrating the free radical inhibition activities exhibited by samples containing malachite powder and salicylic acid in S water, in comparison with samples containing the same components in de-ionized water.

### DETAILED DESCRIPTION OF THE INVENTION

Except in operating and comparative examples, or where otherwise explicitly indicated, all numbers in this description indicating amounts or ratios of material or conditions of reaction, physical properties of materials and/or use are to be understood as modified by the word “about.” All amounts or concentrations are defined by percentage by weight of the final composition, unless otherwise specified.

Inventors of the present invention have discovered that mineral ions from a water-insoluble mineral may be effectively solubilized in structured water and can bond to charged clusters of water molecules in such structured water to form stable cluster complexes. Certain biological activities, such as free-oxygen radical inhibition activity, anti-collagenase activity, and/or collagen synthesis activity, of the mineral ions may be enhanced in such cluster complexes, in comparison with mineral ions in un-structured waters, such as de-ionized water.

As noted above, structured water is known in the art. In particular, I and S waters are derived from feed water which has conductivity, C (μS/cm), of about 250 to 450, and a pH of about 5.0 to 7.5. Interaction of the dipolar molecular structure of tap water with an electrical field simultaneously produces I and S water. The conductivity of I water is characterized by C (μS/cm) of about 500 to 3500, and a pH of about 2.0 to 4.0, and the conductivity of S water is characterized by C (μS/cm) of about 600 to 2500, and a pH of about 10.0 to 12.0. For further details about structured waters and the processes of making same, see Romanian Patents No. RO 88053, RO 88054, RO 107544, RO 107545, and RO 107546; UK Patent Application Publication No. GB 2335142; and U.S. Pat. Nos. 5,846,397, 6,139,855, 6,231,874, 6,451,328, and 6,958,163, the contents of which are incorporated herein by reference in their entireties for all purposes. Such known structures and processes are not repeated herein, in order to avoid obscuring the present invention. Specifically, structure waters used in the present invention may include I water, S water, or a combination thereof.

Any suitable mineral ions that can be used in a cosmetic or pharmaceutical composition may be incorporated into the structured water of the present invention. Examples of suitable mineral ions include, but are not limited to: copper, manganese, selenium, silicon, zinc, iron, aluminum, calcium, potassium, sodium, lithium, magnesium, silver, and combinations thereof. Such mineral ions are typically contained in water-insoluble minerals or gemstones, such as malachite, azurite, chrysocolla, rhodochrosite, rhodonite, tourmaline, ruby, calcite, hematite, etc.

More preferably, the mineral ions are selected from the vital ions, such as copper, manganese, selenium, silicon, zinc, and iron. These vital ions are said to have certain biological activities that may be beneficial to the skin and are therefore particularly useful for forming topical compositions. For example, copper ions from malachite or azurite are said to have anti-collagenase, anti-oxidant, anti-bacterial, and anti-acne activities. For another example, manganese ions from rhodochrosite are said to have collagenase synthesis activities. However, when incorporated into the charged clusters in the structured water, the mineral ions exhibit significantly enhanced biological activities, in comparison with mineral ions in un-structured waters, such as de-ionized water. Such enhanced biological activities are demonstrated in the examples provided hereinafter.

The concentration of the mineral ions in the compositions of the present invention may vary, depending on the type of mineral ions used. Typically, the concentration of the mineral ions in the compositions of the present invention may range from about 2 ppm to about 2000 ppm. Specifically, for copper ions, the concentration may range from about 2 ppm to about 5000 ppm, more preferably about 100 ppm. For manganese ions, the concentration may range from about 3 ppm to about 500 ppm. It should be noted that the concentration of the mineral ions in the structured water affects the stability of the mineral ion agents within the cluster structure of structured water. If the concentration of mineral ions is too great, the mineral ions may precipitate out of the solution.

When the cluster complex contains only the charged cluster of water molecules and the mineral ion, the composition exhibits little or no color. However, when certain bridging agents and capping agents are incorporated into the cluster complex in addition to the mineral ion, the resulting composition exhibits a bright and intense color with unexpected and surprising color stability.

Specifically, the bridging agents as used in the compositions of the present invention function to facilitate electron movements within the cluster complex and to impart a characteristic color to the compositions. Suitable bridging agents that can be used for practicing the present invention include, but are not limited to, organic acids such as citric acid, salicylic acid, glutamic acid, and aspartic acid. Compositions containing such bridging agent exhibit bright and intense colors, such as violet, blue, green, yellow, and red, while compositions without any bridging agent exhibit very pale colors or no color at all. The concentration of bridging agent in the compositions of the present invention typically ranges from about 0.01% to 5%, preferably from 0.1% to 2%, and more preferably from 0.2% to 1%, by total weight of the composition.

Further, the capping agents as used in the compositions of the present invention function to balance the electric charges within the cluster complex and to fix/stabilize the colors formed in the compositions. As mentioned hereinabove, selection of capping agents depends on the specific types of structure water used in the composition. For example, capping agents suitable for use in compositions containing I water include positively charged amino acids, such as arginine, lysine, and histidine, or additional I water. For another example, capping agents suitable for use in compositions containing S water include additional S water. Compositions with the capping agent exhibit unexpected and surprising color stability, i.e., lack of any color fading or color precipitation for a period of at least four (4) weeks at an elevated temperature of about 50° C., while compositions without the capping agent show significant color fading or color precipitation over time. The suitable concentration of capping agent in the compositions of the present invention depends on the type of capping agent used. When a positively charged amino acid is used as the capping agent, the concentration typically ranges from 0.01% to 5%, preferably from 0.1% to 2%, and more preferably from 0.2% to 1%, by total weight of the composition. When additional I or S water is used as the capping agent, the concentration may range widely from about 1% to about 99%, and more preferably from about 3% to about 55%, by total weight of the composition.

The mineral ions, bridging agents, and capping agents as described hereinabove are bound to the negatively and/or positively charged clusters of water molecules in the structured I and/or S water, thereby forming cluster complexes. As a result, the mineral ions are stabilized within the structured water. More importantly, the mineral ions as incorporated in the cluster complexes exhibit significantly enhanced biological activities when compared to mineral ions in un-structured waters, such as deionized water. The enhanced biological activities exhibited by the mineral ions in the structured water of the present invention include, for example, free radical inhibition activity, anti-oxidant activity, anti-collagenase activity, collagen synthesis activity, anti-acne activity and anti-bacterial activity, etc. Further, bright and intense colors are imparted to the resulting compositions with surprisingly and unexpectedly stability. Such bright and intense colors include, but are not limited to: violet, blue, green, yellow, and red. The specific biological activities and colors of exemplary compositions of the present invention are illustrated in greater details hereinafter.

The composition of the present invention as described hereinabove can also be used to provide mineral ion activity in any topical or non-topical cosmetic or pharmaceutical product in which there is an aqueous component. For example, the composition of the present invention can constitute the entire aqueous component of the cosmetic or pharmaceutical product. Alternatively, the composition of the present invention can constitute only a portion of a traditional aqueous component, i.e., it is combined with other non-structured aqueous components, such as distilled water or floral water. The use of non-structured water with structured water is possible because of the specificity and the stability of the structured water.

The composition of the present invention as described hereinabove can be used as a purely aqueous vehicle, as part of a hydroalcoholic vehicle, or as part of the aqueous phase of any emulsion such as, for example, a water-in-oil or oil-in-water emulsion. Any form of vehicle suitable for topical application to the skin, such as, for example, solutions, colloidal dispersions, emulsions, suspensions, creams, lotions, gels, foams, mousses, sprays and the like, can be used to incorporate the composition of the present invention. For example, it can be used in skin care products, such as cleansers, toners, moisturizers, masks, scrubs, and the like, and it can be used in makeup products, such as lipsticks and glosses, foundations, blushes, eyeliners, eye shadows and the like. It will also be useful in treatment products, including pharmaceutical products, in which the stability of the mineral ions is particularly crucial.

Other biological active agents can be added to the composition of the present invention, depending on the specific benefit(s) desired. Routine experimentation can determine the amounts of such biological active agents required to retain a stable composition. The biological active agents can be added directly to the structured water before formation of the composition of the present invention, or to the composition of the present invention after the formation thereof. The type of biological active agent added can be any which is beneficially used in a topical cosmetic or pharmaceutical composition. For example, the structured water can contain within its cluster structure, moisturizing actives, agents used to treat age spots, keratoses and wrinkles, as well as analgesics, anesthetics, anti-acne agents, antibacterials, antiyeast agents, antifungal agents, antiviral agents, antidandruff agents, antidermatitis agents, antipruritic agents, antiemetics, antimotion sickness agents, anti-irritant agents, anti-inflammatory agents, antihyperkeratolytic agents, anti-dry skin agents, antiperspirants, antipsoriatic agents, antiseborrheic agents, hair conditioners and hair treatment agents, antiaging agents, antiwrinkle agents, sunscreen agents, antihistamine agents, skin lightening agents, depigmenting agents, wound-healing agents, vitamins, corticosteroids, self-tanning agents, or hormones.

In a particularly preferred, but not necessary, embodiment of the present invention, the composition of the present invention may further include one or more fragrances, such as natural essential oils from plants or synthetic fragrances. Such fragrances, although typically insoluble in water, can be effectively solubilized by the structured water of the present invention and become a part of the cluster complex, without the use of any solubilizer.

The present invention in a further aspect relates to methods of making the above described compositions. Specifically, in order to effectively release the desired mineral ions from the respective water-insoluble minerals, the water-insoluble minerals are first broken down to particles having an average particle size from about 1 micron to about 1 mm, more preferably from about 10 microns to about 0.1 mm. In order to maintain stability and avoid premature precipitation of the mineral ions, it is important that different components are added in specific orders so that electrical charges in the resulting mixture are balanced during each processing step. For example, when the structure water is I water, it is preferred that the compositions of the present invention are formed by first mixing the water-insoluble mineral particles with I water. Addition of the bridging agent and the capping agent, if desired, should be carried out subsequently in a sequential order. When the structure water is S water, it is preferred that the compositions of the present invention are formed by first adding the bridging agent into the S water, followed by mixing the water-insoluble mineral particles with the S water and bridging agent mixture. Addition of the capping agent, if desired, should be carried out subsequently. Un-dissolved particles of the water-insoluble mineral can be removed from the mixture by a filter having retention threshold from about 0.01 micron to about 1 micron. Examples are provided hereinafter to illustrate the specific processing steps for forming specific compositions of the present invention.

### EXAMPLE I

I water and de-ionized water were both mixed with 1 wt % of malachite powder having a particle size of 40-60 microns. Both mixtures were continuously stirred at a rate of 150 RPM for 72 hours and then sterile filtered. The filtered mixture of I water and malachite powder was named I-MALACHITE WATER. It was a clear solution having a pH value of about 4.85 with a very faint blue color. The filtered mixture of de-ionized water and malachite powder was named D-MALACHITE WATER, which is a clear solution having a pH value of about 6.48. Atomic absorption spectrometry was used to determine the concentrations of the mineral ions (i.e., copper ion in this case) in both solutions. Specifically, the D-MALACHITE WATER contained less than 0.1% ppm of copper ions, while the I-MALACHITE WATER contained about 125 ppm of copper ions.

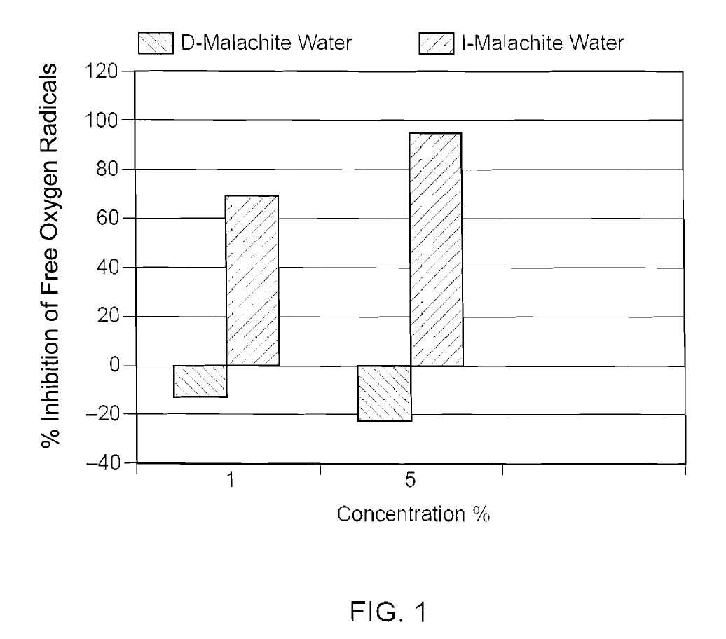

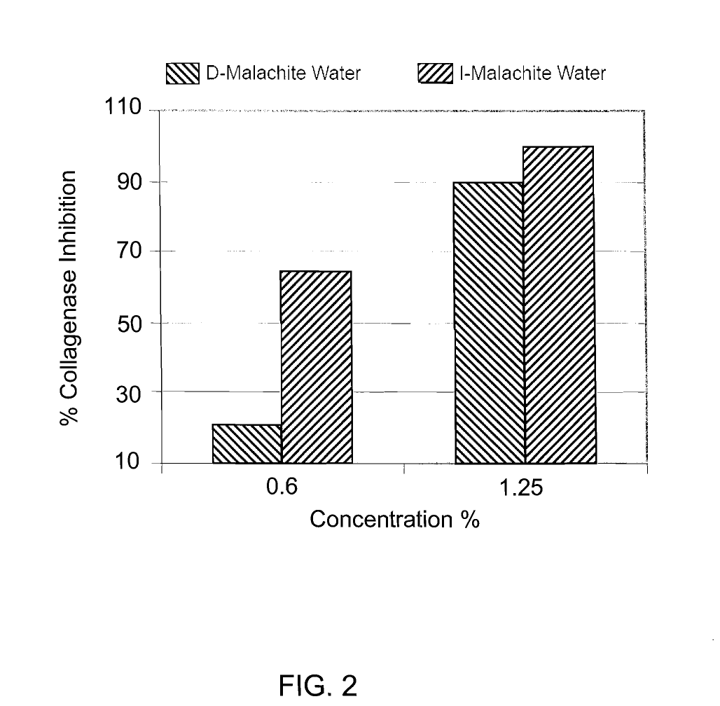

The biological activities of copper ions in the I-MALACHITE WATER were then compared with the biological activities of copper ions in the D-MALACHITE WATER. Specifically, FIG. 1 shows the relative free oxygen radical inhibition activities of the I-MALACHITE WATER and the D-MALACHITE WATER, which were used as stock solutions and measured at further diluted concentrations of about 1% (by volume) and 5% (by volume) during the free oxygen radical inhibition tests. Further, FIG. 2 shows the relative collagenase inhibition activities of the I-MALACHITE WATER and the D-MALACHITE WATER, which were used as stock solutions and measured at further diluted concentrations of about 0.6% (by volume) and 1.25% (by volume) during the collagenase inhibition tests. The biological activity test results as shown in FIGS. 1 and 2 demonstrate that the I-MALACHITE WATER has enhanced free oxygen radical inhibition activity and enhanced collagenase inhibition activity, as compared to D-MALACHITE WATER.

Regarding the free oxygen radical inhibition tests used in the present invention, as described hereinabove and hereinafter, it is known that activation of polymorphonuclear (PMN) leukocytes in the presence of opsonized zymosan generates free oxygen radicals, which are associated with light energy emissions (chemiluminescence activity). Such chemiluminescence activity, once intensified by luminol, is readily quantifiable by a luminometer as an indicator of the amount of free oxygen radical released from the activated PMN leukocytes. The free radical inhibition tests as used in the present invention were therefore carried out using a Micro Lumat Plus luminometer manufactured by EG & G Berthold, which measured the zymosan-induced and luminol-enhanced chemiluminescence from PMNs for determining the amount of free oxygen radicals released thereby. Specifically, the luminometer determined the amount of free oxygen radicals released by PMNs in the presence of a test sample, as well as the amount of free radicals released by PMNs in a non-inhibitory control sample (positive control), and automatically processed the experimental results to provide a percentage (RLO). Such a percentage (RLO) represented the amount of free oxygen radical released by PMNs in the test sample over that released by PMNs in the control sample. The percentage (RLO) was then subtracted from 100 to provide an inhibition percentage, which represented the inhibitory effect of the test sample on the free oxygen radical release by PMNs. The higher the inhibition percentage, the higher the free oxygen radical inhibitory effect of the test sample.

Regarding the collagenase inhibition tests used in the present invention, as described hereinabove and hereinafter, it is known that collagenase is capable of digesting the triple native collagen fibrous at the helical regions of collagen and causing collagen degradation. The collagenase inhibition tests as used in the present invention were therefore carried out using an artificial collagenase substrate (4-phenyl-azo-benzyl-oxycarbonyl-Pro-Leu-Gly-Pro-D-Arg), which can be enzymatically split by collagenase to form a lipophilic colored product (4-phenyl-azo-benzyl-oxycarbonyl-Pro-Leu). The lipophilic colored product, after extraction by ethyl acetate, can be quantified using a spectrophotometer at a wavelength of about 320 nm, as a measure of the collagenase activity. A first composition containing only the artificial collagenase substrate and calcium chloride in a phosphate buffer saline (PBS) without any collagenase was provided as “Control 1,” which acted as a negative control sample to indicate complete absence of collagenase activity. A second composition containing the artificial collagenase substrate, calcium chloride, and collagenase in a phosphate buffer saline (PBS) was provided as “Control 2,” which acted as a positive control sample to indicate full and un-inhibited collagenase activity. The composition whose collagenase inhibitory activity was to be tested was then mixed together with the artificial collagenase substrate, calcium chloride, and collagenase in a phosphate buffer saline (PBS) to form a “Sample” composition. 1 ml of citric acid and 2.5 ml of ethyl acetate were then sequentially added to the Control 1, Control 2, and Sample compositions. Upper-phase contents from the Control 1, Control 2, and Sample compositions were collected and respectively placed into 150 mg of Na₂SO₄ solution, kept at room temperature for about 25 minutes, and the liquid contents of each composition were read by a UV-VIS spectrophotometer at the wavelength of about 320 nm in quartz curvette. An absorbance unit (AU) was recorded for each composition, which indicated the optical density value thereof. The collagenase inhibition activity of the composition to be tested was calculated as a percentage (%) as follows:

% Inhibition=100−(AU Sample−AU Control 1)/(AU Control 2−AU Control 1)×100,

in which the higher the percentage, the higher the collagenase inhibition activity.

### EXAMPLE II

0.4 gram of commercially purchased malachite powder was mixed with 98.6 grams of I water and continuously stirred for two (2) hours. 0.5 gram of 1-glutamic acid (bridging agent) was then added into the mixture, which was continuously stirred for five (5) hours. Un-dissolved malachite powder was removed from the solution by filtration using a filter having a retention threshold of about 0.22 micron. The pH value of the mixture after filtration was measured, which was approximately 3.97. Finally, 0.5 gram of L-arginine (capping agent) was added into the mixture, which was continuously stirred for about five (5) to ten (10) minutes. The pH value of the mixture after addition of the L-arginine was measured again, which was approximately 4.90. No preservatives were added. The resulting solution was characterized by a stable violet color and was named I-MALACHITE (LGA-LA) WATER.

Similarly, 0.4 wt % of commercially purchased malachite powder was mixed with 98.6 wt % of de-ionized water and continuously stirred for two (2) hours. The pH value of the mixture was measured, which was about 6.35. 0.5 wt % of 1-glutamic acid (bridging agent) was then added into the mixture, which was continuously stirred for five (5) hours. The pH value of the mixture was again measured, which was about 4.31. Next, 0.5 wt % of L-arginine (capping agent) was added into the mixture, which was continuously stirred for about ten (10) to thirty (30) minutes. Un-dissolved malachite powder was removed from the solution by filtration using a filter having a retention threshold of about 0.22 micron. The pH value of the mixture after filtration was measured, which was approximately 5.47. No preservatives were added. The resulting solution has a violet color and was named D-MALACHITE (LGA-LA) WATER.

Atomic absorption spectrometry was used to determine the concentrations of the mineral ions (i.e., copper ion in this case) in both solutions. Specifically, the D-MALACHITE (LGA-LA) WATER contained about 1140 ppm of copper ions, while the I-MALACHITE (LGA-LA) WATER contained about 1435 ppm of copper ions.

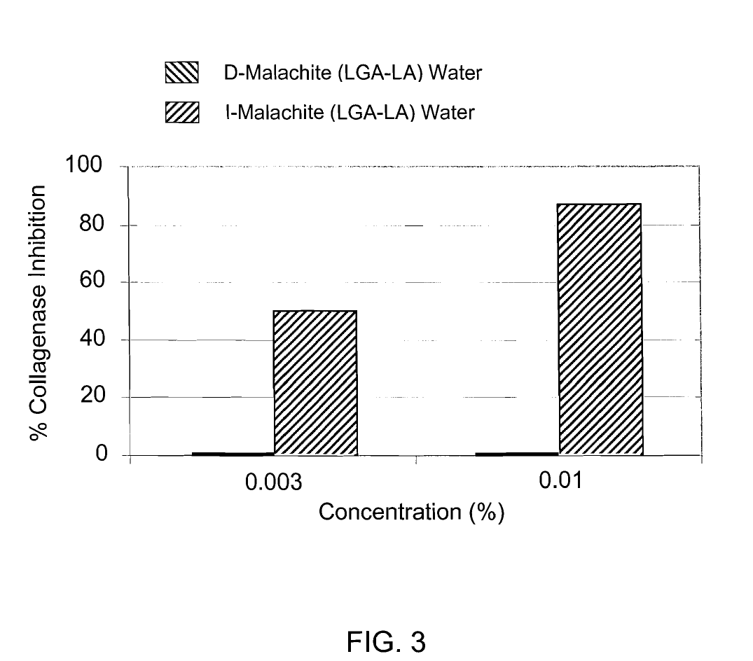

The collagenase inhibition activities of copper ions in the I-MALACHITE (LGA-LA) WATER were then compared with the biological activities of copper ions in the D-MALACHITE (LGA-LA) WATER. Specifically, FIG. 3 shows the relative collagenase inhibition activities of the I-MALACHITE (LGA-LA) WATER and the D-MALACHITE (LGA-LA) WATER, which were used as stock solutions and was measured at further diluted concentrations of about 0.003% (by volume) and 0.01% (by volume) during the collagenase inhibition tests. The test results as shown in FIG. 3 demonstrate that the I-MALACHITE (LGA-LA) WATER has enhanced collagenase inhibition activity, as compared to D-MALACHITE (LGA-LA) WATER.

### EXAMPLE III

I water was infused with 5 wt % rhodochrosite particles having a particle size of about 0.5 mm for 48 hours. The mixture was continuously stirred at a rate of about 150 RPM. After 2 hours 0.5 wt % of citric acid was added into the infusion process. The infusion process was stopped after 46 hours and the solution was sterile filtered. The solution so obtained had a yellow color and was named I-RHODOCHROSITE (CA) WATER. Atomic absorption spectrometry was used to determine the concentrations of the mineral ions (i.e., manganese ion in this case) in the solution. Specifically, the I-RHODOCHROSITE (CA) WATER contained about 692 ppm of manganese ions.

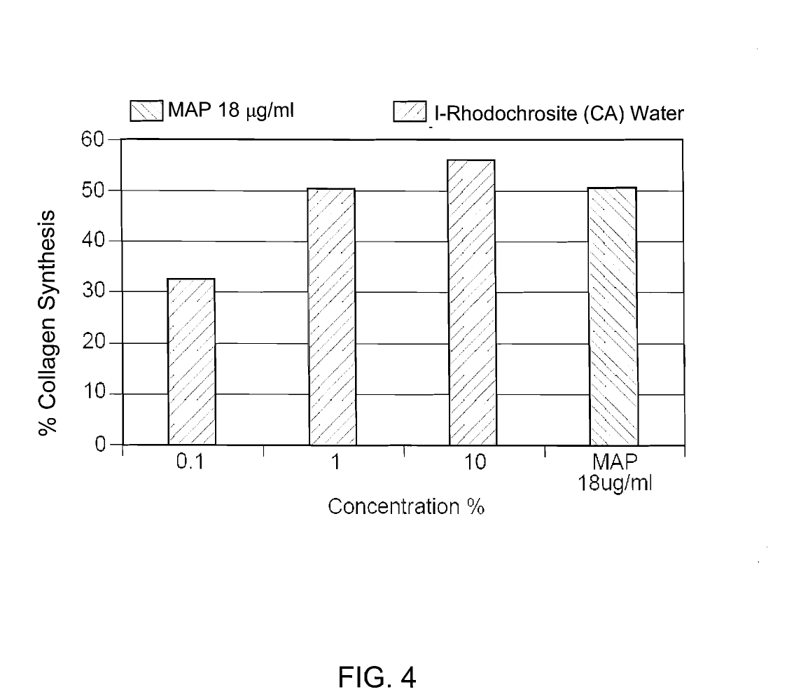

The collagen synthesis activity of manganese ions in the I-RHODOCHROSITE (CA) WATER was then measured, using 18 μg/ml of Magnesium-Ascorbil-Phosphate (MAP) as a positive control sample. Specifically, FIG. 4 shows the relative collagen synthesis activities of the I-RHODOCHROSITE (CA) WATER and the 18 μg/ml MAP solution, while the I-RHODOCHROSITE (CA) WATER was used as a stock solution and was measured at further diluted concentrations of about 0.01% (by volume), 1% (by volume), and 10% (by volume) during the collagen synthesis tests. The test results as shown in FIG. 4 demonstrate that the I-RHODOCHROSITE (CA) WATER has significant collagen synthesis activity, comparable to that of MAP, which is a known collagen synthesis enhancer.

The collagen synthesis activity tests as described hereinabove were carried out in vitro using human embryotic fibroblast cells. Specifically, collagen synthesized by the human embryotic fibroblasts grown in a culture medium can be stained by a dye, i.e., Direct Red 80—Fluka 43665, and then calorimetrically measured at a wavelength of about 540 nm. A “Control” growth medium contained only a Basal Modified Eagle (BME)-Sigma B1522 growth medium supplemented with 10% of fetal calf serum (FCS)-Sigma F 2442 was provided. The respective composition whose collagenase synthesis activity was to be tested was mixed with BME and 10% FCS to form a “Sample” grown medium. Further, 18 μg/ml of MAP was added into the culture medium to form a “Positive Control” grown medium. The human embryotic fibroblast cells respectively grown in such Control, Sample and Positive Control media were harvested, and the amount of collagen synthesized by the respective human embroytic fibroblast cells was measured according to the above-described method. The respective absorbance units (AU), which is indicative of the amount of collagen synthesized, was then recorded. The collagen synthesis activity of the composition to be tested was calculated as a percentage (%) as follows:

% Collagen synthesis=(AU Sample/AU Control)×100−100

in which the higher the percentage, the higher the collagen synthesis activity.

### EXAMPLE IV

0.2 gram of salicylic acid (bridging agent) was added into 99.75 grams of S water and continuously stirred for two (2) hours. 0.05 gram of commercially purchased malachite powder was then mixed with the S water and salicylic acid mixture, which was continuously stirred for five (5) hours. Un-dissolved malachite powder was removed from the solution by filtration using a filter having a retention threshold of about 0.22 micron. The pH value of the mixture after filtration was measured, which was approximately 3.62. The resulting mixture was mixed with equal amount of additional S water (capping agent) and then filtered again using a filter with a retention threshold of about 0.22 micron. The pH of the mixture after the second filtration step was measured, which was approximately 5.18. No preservatives were added. The resulting solution was characterized by a stable green color and was named S-MALACHITE (SA) WATER

Similarly, 0.2 wt % of salicylic acid (bridging agent) was added into 99.75 wt % of de-ionized water and continuously stirred for two (2) hours. The pH value of the mixture was measured, which was about 2.58. 0.05 wt % of commercially purchased malachite powder was then mixed with the de-ionized water and salicylic acid mixture, which was continuously stirred for five (5) hours. The pH value of the mixture was again measured, which was approximately 3.26. The mixture was then mixed with equal amount of additional de-ionized water and stirred for about five (5) to about ten (10) minutes. Subsequently, un-dissolved malachite powder was removed from the solution by filtration using a filter having a retention threshold of about 0.22 micron. The pH value of the solution after filtration was measured, which was approximately 3.30. No preservatives were added. The resulting solution was colorless, transparent and was named D-MALACHITE (SA) WATER.

Atomic absorption spectrometry was used to determine the concentrations of the mineral ions (i.e., copper ion in this case) in both solutions. Specifically, the D-MALACHITE (SA) WATER contained about 120 ppm of copper ions, while the S-MALACHITE (SA) WATER contained about 115 ppm of copper ions.

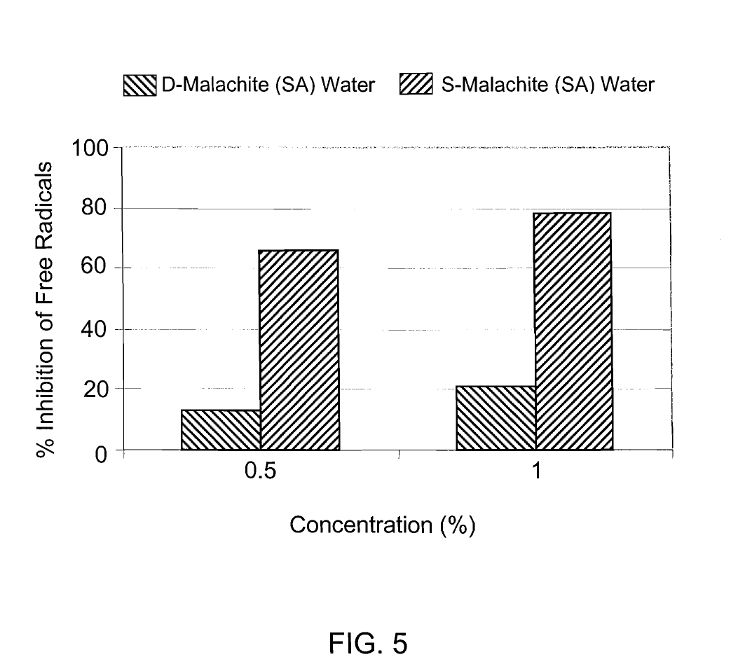

The free oxygen radical inhibition activities of copper ions in the S-MALACHITE (SA) WATER were then compared with the biological activities of copper ions in the D-MALACHITE (SA) WATER. Specifically, FIG. 5 shows the relative free oxygen radical inhibition activities of the S-MALACHITE (SA) WATER and the D-MALACHITE (SA) WATER, which were used as stock solutions and was measured at further diluted concentrations of about 0.5% (by volume) and 1% (by volume) during the free oxygen radical inhibition tests. The test results as shown in FIG. 5 demonstrate that the S-MALACHITE (SA) WATER has enhanced free radical inhibition activity, as compared to D-MALACHITE (SA) WATER.

### EXAMPLE V

0.4 gram of commercially purchased malachite powder was mixed with 98.3 grams of I water and continuously stirred for two (2) hours. 0.5 gram of citric acid (bridging agent) was then added into the mixture, which was continuously stirred for five (5) hours. Un-dissolved malachite powder was removed from the solution by filtration using a filter having a retention threshold of about 0.22 micron. The pH value of the mixture after filtration was measured, which was approximately 3.05. Finally, 0.6 gram of L-arginine (capping agent) was added into the mixture, which was continuously stirred for about ten (10) minutes. The pH value of the mixture after addition of the L-arginine was measured again, which was approximately 4.25. No preservatives were added. The resulting solution was characterized by a stable blue color.

### EXAMPLE VI

1 gram of crushed rhodochrosite particles having an average particle size of about 0.1 mm were mixed with 98.5 grams of I water and 0.5 gram of citric acid (bridging agent), which were continuously stirred for eight (8) hours. Un-dissolved rhodochrosite particles were removed from the solution by filtration using a filter having a retention threshold of about 0.22 micron. Finally, 0.2 gram of L-arginine (capping agent) was added into the mixture. The pH value of the mixture after addition of the L-arginine was measured, which was approximately 4.24. No preservatives were added. The resulting solution was characterized by a stable yellow color.

### EXAMPLE VII

0.8 gram of salicylic acid (bridging agent) was added into 377 grams of S water and continuously stirred for one (1) hour. The pH of the S water and salicylic acid mixture was measured, which was approximately 2.72. 2.0 grams of crushed rhodochrosite particles having an average particle size of about 0.1 mm were added into the S water and salicylic acid mixture and continuously stirred for about five (5) hours. The pH of the mixture after addition of the rhodochrosite particles was again measured, which was approximately 5.43. 20 grams of additional S water (capping agent) was added into the mixture and continuously stirred for about five (5) to ten (10) minutes. The pH of the mixture after addition of the additional S water was measured, which was approximately 6.38. Un-dissolved rhodochrosite particles were removed from the solution by filtration using a filter having a retention threshold of about 0.22 micron. The pH value of the mixture after filtration was again measured, which was approximately 6.31. No preservatives were added. The resulting solution was characterized by a stable red color.

While the invention has been described herein with reference to specific aspects, features and embodiments, it will be recognized that the invention is not thus limited, but rather extends to and encompasses other variations, modifications and alternative embodiments. Accordingly, the invention is intended to be broadly interpreted and construed to encompass all such other variations, modifications, and alternative embodiments, as being within the scope and spirit of the invention as hereinafter claimed.

What is claimed is:

1. A composition comprising structured water selected from the group consisting of I water, S water, and a combination thereof, wherein said structured water comprises at least one charged cluster of water molecules having at least one mineral ion bound therewith to form a cluster complex.

2. The composition of claim 1, wherein the at least one mineral ion is selected from the group consisting of copper, manganese, selenium, silicon, zinc, iron, aluminum, calcium, potassium, sodium, lithium, magnesium, silver, and combinations thereof.

3. The composition of claim 2, wherein the at least one mineral ion is a positively charged mineral ion selected from the group consisting of copper, manganese, selenium, silicon, zinc, and iron.

4. The composition of claim 1, wherein the at least one mineral ion is released by a water-insoluble mineral that is selected from the group consisting of malachite, azurite, chrysocolla, rhodochrosite, rhodonite, tourmaline, ruby, calcite, hematite, and combinations thereof.

5. The composition of claim 1, which is colorless.

6. The composition of claim 1, wherein the cluster complex further comprises a bridging agent bound to the at least one charged cluster of water molecules.

7. The composition of claim 6, wherein the bridging agent comprises an organic acid selected from the group consisting of citric acid, salicylic acid, glutamic acid, and aspartic acid.

8. The composition of claim 6, wherein the cluster complex further comprises a capping agent bound to the at least one charged cluster of water molecules.

9. The composition of claim 8, wherein the structured water is I water, and wherein the capping agent is selected from the group consisting of arginine, lysine, histidine, and additional I water.

10. The composition of claim 8, wherein the structured water is S water, and wherein the capping agent comprises additional S water.

11. The composition of claim 8, which is characterized by a stable color selected from the group consisting of violet, blue, green, yellow, and red.

12. The composition of claim 8, wherein the structured water is I water comprising negatively charged clusters of water molecules, wherein at least one of said negatively charged clusters of water molecules is bound with copper ions, citric acid, and L-arginine to form the cluster complex, and wherein said composition is characterized by a stable blue color.

13. The composition of claim 8, wherein the structured water is I water comprising negatively charged clusters of water molecules, wherein at least one of said negatively charged clusters of water molecules is bound with copper ions, glutamic acid, and L-arginine to form the cluster complex, and wherein said composition is characterized by a stable violet color.

14. The composition of claim 8, wherein the structured water is S water comprising positively charged clusters of water molecules, wherein at least one of said positively charged clusters of water molecules is bound with salicylic acid, copper ions, and additional S water to form the cluster complex, and wherein said composition is characterized by a stable green color.

15. The composition of claim 8, wherein the structured water is I water comprising negatively charged clusters of water molecules, wherein at least one of said negatively charged clusters of water molecules is bound with manganese ions, citric acid, and L-arginine to form the cluster complex, and wherein said composition is characterized by a stable yellow color.

16. The composition of claim 8, wherein the structured water is S water comprising positively charged clusters of water molecules, wherein at least one of said positively charged clusters of water molecules is bound with salicylic acid, manganese ions, and additional S water to form the cluster complex, and wherein said composition is characterized by a stable red color.

17. The composition of claim 1, further comprising one or more fragrances that are solubilized and incorporated into the cluster complex, wherein said composition is essentially free of solubilizer.

18. A method for forming a composition, comprising mixing particles of a water-insoluble mineral with I water, wherein at least a portion of the water-insoluble mineral is solubilized and releases at least one positively charged mineral ion to bond with at least one negatively charged cluster of water molecules in the I water to form a cluster complex.

19. The method of claim 18, wherein the water-insoluble mineral particles have an average particle size ranging from about 1 micron to about 1 mm.

20. The method of claim 18, further comprising adding at least one bridging agent into the mixture to bond with the at least one positively charged mineral ion and form a part of the cluster complex, wherein said at least one bridging agent comprises an organic acid selected from the group consisting of citric acid, salicylic acid, glutamic acid, and aspartic acid.

21. The method of claim 19, further comprising adding at least one capping agent into the mixture to bond with the at least one bridging agent and form a part of the cluster complex, wherein the at least one capping agent is selected from the group consisting of arginine, lysine, histidine, and additional I water.

22. The method of claim 21, wherein un-dissolved particles of the water-insoluble mineral is removed from the mixture by filtration after addition of the at least one bridging agent, but before addition of the at least one capping agent.

23. A method for forming a composition, comprising:
adding at least one bridging agent into S water, wherein said at least one bridging agent comprises an organic acid selected from the group consisting of citric acid, salicylic acid, glutamic acid, and aspartic acid for bonding with at least one positively charged cluster of water molecules in the S water; and
mixing particles of a water-insoluble mineral with the S water and bridging agent mixture, wherein at least a portion of the water-insoluble mineral is solubilized and releases at least one positively charged mineral ion for bonding with the at least one bridging agent to form a cluster complex.

24. The method of claim 23, wherein the water-insoluble mineral particles have an average particle size ranging from about 1 micron to about 1 mm.

25. The method of claim 23, further comprising adding additional S water as a capping agent into the mixture to bond with the positively charged mineral ion and form a part of the cluster complex.

26. The method of claim 25, wherein un-dissolved particles of the water-insoluble mineral is removed from the mixture by filtration having a retention threshold ranging from about 0.01 micron to about 1 micron after mixing particles of the water-insoluble mineral with the S water and bridging agent mixture, but before addition of the additional S water.
